(19) United States
(12) Patent Application Publication
(10) Pub. No.: US 2005/0171367 A1
(43) Pub. Date: Aug. 4, 2005

(54) Method for manufacturing a combined fatty acid / lecithin ruminally protected feed supplement.

(75) Inventor: Terry Stephen DeLoach, Easley, SC (US)

Correspondence Address: TERRY S. DELOACH, 217 STONEHEDGE COURT, EASLEY, SC, 29642, US

(73) Assignees: Terry Stephen DeLoach, Easley, SC (US); ALBA INTERNATIONSL, North Aurora, IL (US)

(21) Appl. No.: 10/708,024

(22) Filed: Feb. 3, 2004

(51) Int. Cl. C07F 9/02

(52) U.S. Cl. 554/78

(57) ABSTRACT

A method for the preparation of a rumen stable bypass feed ingredient which is a fatty acid/crude lecithin calcium salt matrix derived from products of the alkali, caustic or “wet refining” processing of vegetable oils. In which, an admixture is formed of reactive ingredients consisting of: (a) a C.sub.10-C.sub.22 or higher fatty acid mixture having greater than about 30 weight % of the C.sub.10-C.sub.22 fatty acid content in the form of mixed vegetable fatty acids or fatty acid glycerides. (b) from about 10 to about 30% of the total admixture weight of calcium oxide. (c) 10 to about 45% crude lecithin derived from the alkali, caustic or wet refining processing of vegetable oils. Water is then added to the admixture in an amount between about 10% and about 100% by weight relative to the amount of calcium oxide. And the admixture is then heated to a temperature at which the fatty acid glycerides saponify to form fatty acid calcium salts in the presence of the crude lecithin. Both the calcium salts of fatty acids and crude lecithin are enhanced with bypass feed qualities. Rumen bypass feed supplements are also disclosed, as well as ruminant feeds containing the feed supplements and processes for supplying the feed supplements to ruminant animals.

### BACKGROUND OF INVENTION

The present invention relates to a process for the production of rumen bypass feed supplements that are useful as an energy source for ruminants. The process is unique by converting products (wet or dried gums) from the alkali, caustic or “wet refining” processing of vegetable oil seed stocks into a ruminally protected fatty acid/crude lecithin calcium salt matrix. The “wet refining process” differs from the typical alkali or caustic (being widely used) refining process. The “wet refining process” is referenced in US Patents listed below as well as others of a similar nature demonstrating the well known and still developing art:

U.S. Pat. No. 4,049,686: Describes process where triglyceride oils from vegetable oil seed stocks are refined according to a two-stage process, in which in the first step a substantially concentrated solution of an acid or an anhydride is mixed with the crude oil in which a second step an aqueous rafinate is separated from the oil, the rafinate containing a mixture of “mixed triglycerides, fatty acids, and crude lecithins”.

U.S. Pat. No. 5,696,278: Described invention relates to a process for the preparation of refined glyceride oils, which comprises applying an aqueous acid refining treatment to a crude glyceride oil which has not substantially been exposed to enzymatic activity. And also generating aqueous phase mixed fatty acid, triglycerides and crude lecithins.

U.S. Pat. No. 6,172,248: Describes an organic acid refining process, vegetable oil is combined with a dilute aqueous organic acid solution and subjected to high shear to finely disperse the acid solution in the oil. The resulting acid-and-oil mixture is mixed at low shear for a time sufficient to sequester contaminants into a hydrated mixed triglycerides, fatty acids, and crude lecithins phase, and producing a purified vegetable oil phase. Hydrated mixed triglycerides, fatty acids, and crude lecithins are used in this novel application.

The present invention also relates to processes in which a mixed triglycerides, fatty acids, and crude lecithins (TFCL) product stream from the alkali, caustic or “wet refining” processing of vegetable oils is employed in the formation of a mixed free flowing granular fatty acid/crude lecithin calcium salt matrix. Further, that the fatty acid/crude lecithin calcium salt matrix provides ruminant protection and source of ruminally protected choline (RPC) not described for these source materials in other noted patents.

Previous familiar forms in which fatty acids in general are protected from microbial action in the rumen are fatty acid calcium salts disclosed in U.S. Pat. Nos. 4,642,317 and 4,826,694 and others not listed are widely accepted examples in the cattle industry and accepted as providing nutritional benefit to the bovine diet.

Conventional cattle feeds such as corn and alfalfa often fail to provide sufficient energy for cattle, especially lactating dairy cattle during periods of heavy milk production and cattle in the last trimester before calving, when nutrient needs are increasing. Feed containing a high proportion of corn also has a tendency to depress the milk fat content of the milk produced by such cattle. Fat is an excellent energy source, and it is known that if the proportion of fat in cattle food is increased, lactating dairy cattle produce higher milk yields without draining their reserves of body fat and without diminishing the proportion of milk fat in the milk produced.

However, it has been found that if the proportion of fat in the diet of cattle exceeds about 2% of the total feed in solids, the feed has toxic effects upon the microorganisms in the rumen of the cattle. The rumen, the largest of the four stomach compartments of ruminants, is the site of digestive breakdown of ingested foodstuffs. Absorption by the animal, however, takes place further along in the alimentary tract, principally in the abomasum and intestines. Although the rumen endows the animal with the capacity to digest and utilize cellulose effectively, it is relatively inefficient in the digestion and utilization of dietary fats.

Furthermore, fats apparently reduce the growth rate or even kill the microorganisms that digest fiber in the rumen, thereby lowering cellulose digestibility. This deleterious effect on the rumen is particularly true of unsaturated fats. In addition to reducing the growth rate or killing cellulose-digesting microorganisms, triglycerides and free fatty acids can physically coat fibrous or cellulosic material in the rumen and thereby inhibit fermentation of the material by the bacteria. This has an adverse effect on the total digestibility of the diet, and can result in a reduced yield of milk and butterfat.

U.S. Pat. No. 4,642,317 describes the incorporation of insoluble fatty acid salts in ruminant feed as a means of increasing the fatty acid content without deleteriously affecting the ruminant digestion cycle. The present invention provides a feed additive of a fatty acid/crude lecithin calcium salt matrix and functions as a rumen bypass product, and is subsequently metabolized in the abomasum small intestine of the ruminant.

Unlike prior arts this invention incorporates the lecithin and provides a mechanism for emulsification of fats, oils or fatty acids in the post rumen area and enhances fat absorption as well as a source of choline. Producing fatty acid/crude lecithin calcium salt matrix product derived from products of the alkali, caustic or “wet refining” processing of vegetable oils that is a free-flowing granular powder is desirable, so that the product can be easily transported and used in feed rations. This physical form of a fatty acid calcium salt allows for the addition to the feed rations by simple blending with the remaining ingredients.

The critical properties required for a granular fatty acid/crude lecithin calcium salt matrix to be free flowing are that it be tack-free, non-cohesive and have a low dust content. Otherwise, the product will tend to lump, agglomerate, and generate dust in the surrounding environment. The product should also experience minimal particle segregation that would result in a non-homogenous feed ration. It should also be stable from oxidative rancidity.

One way to obtain a free-flowing product is to employ a low glyceride content fatty acid feedstock. This is disclosed in U.S. Pat. No. 5,382,678. This requires intermediate and costly processing of fats and greases to reduce the glyceride content and does not contain the lecithin advantages.

It would be preferable to directly produce a granular fatty acid/crude lecithin calcium salt matrix rumen bypass feed product from high glyceride content materials such as those derived from the products of the alkali, caustic or “wet refining” processing of vegetable oils. These materials are relatively inexpensive products of the oil seed industry. Also preferable is an available alternative rumen bypass feed product devoid of animal byproducts given grave concern over BSE (Bovine Spongiform Encephalopathy) transmission using animal derived byproducts. The U.S. Pat. No. 5,382,678 discloses a process for producing low glyceride content fatty acid calcium salts in the form of tackless free-flowing granules by reacting a fatty acid mixture with a basic calcium compound in an aqueous suspension. However, a reduced glyceride content fatty acid distillate must be employed as the starting material. And the process does not have the lecithin advantage of adding ruminally protected choline (RPC).

There remains a need for a process by which:

(a) A fatty acid/crude lecithin calcium salt matrix rumen bypass feed supplement may be produced in a free-flowing granular form from relatively inexpensive materials originating from oil seed crushing industry and incorporating the nutritional advantages of crude lecithin.

(b) Novel to other similar practices is the incorporation of crude lecithin and the creation of (RPC) ruminally protected choline.

(c) Unique also a provision to satisfy a need to increase alternatives to animal derived feed supplements to eliminate or minimize a possibility of Bovine Spongiform Encephalopathy (BSE) contamination and/or transmission.

(d) Further, for the oil seed industry, the present invention provides an alternative vertical integration of the “wet or dried gums” products into a marketable rumen protected feed ingredient at considerably less cost than refining these materials into a “for suitable for human consumption” end use.

(e) And unlike prior arts the feed ingredient of the present invention incorporates a rumenally protected form of crude lecithin known throughout the industry as an emulsifier providing a mechanism for emulsification in the post rumen digestive area to enhance fat absorption.

### SUMMARY OF INVENTION

The present invention meets this need. It has now been discovered, a fatty acid/crude lecithin calcium salt matrix was developed in the form of a free flowing granular mixture of fatty acid/crude lecithin calcium salts for use as rumen bypass feed supplement may be obtained by reacting “mixed triglycerides, fatty acids, and crude lecithins” derived from the products of the alkali, caustic or “wet refining” processing of vegetable oils with calcium oxide and a minimal amount of water. Therefore, according to one aspect of the present invention, a method for the preparation of a fatty acid/crude lecithin calcium salt matrix product, is provided in which an admixture is formed of reactive ingredients consisting of:

(a)C.sub.10-C.sub.22 or higher fatty acid mixture having greater than about 30 weight % of the C.sub.10-C.sub.22 or higher fatty acid content in the form of mixed vegetable fatty acids and/or fatty acid glycerides

(b)And from about 10 to about 30% of the total admixture weight of calcium oxide.

(c)And 10 to about 45% crude lecithin derived from oil seed gums. Water is then added to the admixture in an amount between about 10% and about 20% by weight relative to the amount of calcium oxide. Heating the admixture to a temperature at which the fatty acid glycerides saponify to form fatty acid calcium salts.

The process of the present invention obtains a fatty acid/crude lecithin calcium salt matrix in the form of free flowing granules from oil seed processing products with glyceride contents of up to 15-85%. The fatty acids or triglycerides and lecithin are directly converted to the calcium salts and without a fatty acid isolation intermediate process step. It is also not necessary to separate the glycerol resulting triglycerolysis. The need to employ energy-intensive processes that diminish the economic viability of fatty acid/lecithin calcium salt rumen bypass feed supplements is eliminated. The process also provides greater flexibility in the choice of vegetable oil feed stocks, which represents an additional economic advantage.

Without being bound by any particular theory, it is believed that the glycerol that is generated complexes with the calcium hydroxide produced by the reaction between the calcium oxide and water, forming compounds such as calcium monoglycerolate, calcium diglycerolate, tricalcium octaglycerolate, calcium hexaglycerolate, as well as hydrated diglycerol salts such as Ca(OH).sub.2.2C.sub.3 H.sub.8 O.sub.3. H.sub.2 O or other hydroxide complexes such as [Ca(C.sub.3 H.sub.8 O.sub.3).sub.3](OH).sub.2. It is believed that the glycerol that is generated complexes with the calcium hydroxide that is present as the admixture is dehydrated, resulting in a form of glycerol that does not interfere with the solidification and milling of the fatty acid calcium salt product into free-flowing granules. Therefore, according to another aspect of the present invention, a fatty acid calcium salt is provided, prepared by the method of the present invention and in the presence of the crude lecithin naturally in the “wet or dried gums”.

The fatty acid distribution of the fatty acid/crude lecithin calcium salt matrix of the present invention corresponds to the fatty acid distribution of the glyceride feed stocks of the particular vegetable oil product used. This can be advantageously utilized to obtain fatty acid distributions that are nutritionally beneficial. Ruminants fed with the fatty acid calcium salt products of the present invention exhibit improved body condition, milk production and reproductive function. The present invention thus also provides a process for supplying fatty acids and lecithin to ruminant animals by feeding to the ruminant animals the fatty acid/crude lecithin calcium salt matrix product of the present invention in an amount equal to at least 1-4% or more of the dry matter content of the animal's feed.

The present invention also includes a ruminant feed containing at least one vegetable material and at least 1-4% or more by weight on a dry solids basis of the fatty acid/crude lecithin calcium salt matrix product of the present invention.

The composition of the present invention also makes use of crude forms of phospholipids naturally occurring in the “wet or dried gums”, which contain a high percentage of unsaturated fatty acids. It is known that unsaturated fatty acids (UFA) have an adverse effect upon the rumen environment. Specifically, UFAs are toxic to microbes, particularly the cellulose digesters, reduce fiber digestion, coat the fiber particles, and lower rumen pH. Therefore, it is critical that the dried granular fatty acid crude lecithin matrix not hydrate readily in the rumen, thereby protecting any active agents and the UFAs and lecithin from the ruminal microorganisms.

The instant matrix of the present invention however, will disintegrate and undergo digestion post-ruminally by the action of hydrochloric acid, pancreatic lipases and other esterases, allowing the active agents to be digested in the intestine. Realization of the rumen bypass matrix is facilitated by the use of multivalent metal salts of phosphatidyl inositol (PI), phosphatidyl ethanolamine (PE), and phosphatidic acid (PA) such as for example, calcium, aluminum, magnesium, iron, manganese, copper, and zinc. Such salts of said phospholipids have a very low hydration rate of .about.1%.

The common commercial production of a multivalent metal/lecithin complex is most easily prepared during the degumming of crude oil. As an example, soybean oil contains up to about 3% phosphatides. A metal salt solution, for example calcium chloride, is added to the crude oil, thereby hydrating the phosphatides and causing them to precipitate from the oil. After drying the precipitate, the resultant product is a metal salt of fatty acids (metal phosphate complexed lecithin) that is insoluble in water and therefore, not readily detected by the enzymes produced in the rumen.

The above and other objects, features and advantages of the present invention will become clear from the following description of the preferred embodiment.

### DETAILED DESCRIPTION

The present invention provides a process by which “mixed triglycerides, fatty acids, and crude lecithins (TFCL)” materials derived from the products of the alkali, caustic or “wet refining” processing of vegetable oil seed stocks may be converted to free-flowing powder or granular fatty acid/crude lecithin calcium salt matrix suitable as rumen bypass feed supplements.

The term “mixed triglycerides, fatty acids, and crude lecithins (TFCL)” as employed herein includes C.sub.10-C.sub.22 fatty acids, fatty monoglycerides, diglycerides and triglycerides, crude lecithin and any mixture thereof. These glyceride forms represent a significant departure from conventional processes for the manufacture of fatty acid calcium salt feed supplements as the lecithin portion is naturally present as derived from the oil seed refining process.

The term “crude lecithin” refers to crude lecithin as a part of “wet or dried gums” derived from the “wet process refining” of oil seed stocks. And from a true chemical sense, refers to phosphatidyl choline. However, as used by commercial suppliers, the term crude lecithin refers to a product derived from vegetable oils, especially soybean oil. In addition to phosphatidyl choline, crude lecithin derived from vegetable oil includes phosphatidyl ethanolamine, phosphatidyl inositol, phosphatidic acid, phosphatidyl serine, cyclolipids, and other components such as free sugars, metals and free fatty acids. Because they contain several phosphatidyl derivatives, commercial lecithins are often referred to as phosphatides or phosphatide concentrates. Other synonymous terms for phosphatide concentrates include wet gums or wet lecithin.

Unique to this invention is the incorporation of lecithin which contains choline an essential ingredient in animal nutrition. A recent University of Minnesota, Department of Animal Science study indicates the following regarding ruminally protected choline (RPC):

“Factors Affecting Economic Efficiency of the Beef Cattle Industry A project to identify and evaluate the impact of nutritional and management factors affecting production efficiencies of the beef cattle production enterprise is getting results. For example, one part of this research evaluated protected choline supplementation on feedlot performance of yearling steers. Supplementing diets of feedlot cattle with protected choline for 100 days improved the incidence of carcasses reaching Choice Y3 or better. At the current price discount for select or severely discounted carcasses, this difference would translate into an advantage of $11.77/head during a 100-day feeding period for cattle supplemented with protected choline. Feeding protected choline may be one-way cattle feeders can enhance the value of cattle without affecting microbial populations.”

The benefits of choline appear clearly defined by those knowledgeable in the art referenced by a number of scientific publications.

Atkins, K. B., and Erdman, 1992 stated “Supplementation of dietary choline in an unprotected form is useless because of extensive ruminal degradation.”

Regarding the effects on milk production, Grummer et al. 1987, Erdman and Sharma 1991: and Sharma and Erdman 1989 indicate that experiments where choline has been supplemented either by feeding in a rumenally protected form or by post ruminal infusion milk production increased 0-3 kg/day.

Johnson et al. (1951) produced a choline dificiency in week old dairy calves using synthetic milk replacer diets containing 15% casein. Choline requirements estimated from those experiments were 260 mg/L of milk replacer. (1733 mg/kg DM).

Szuhaj, Bernard and List, Gary 1985, AOCS monograph “Lecithins” states; “Some compounded chemically modified lecithins function better as fat emulsifiers than does commercial crude lecithin. Lecithin also serves as an appetite stimulant, antioxidant, and vitamine, and mineral source in these feeds and promotes healthy coatss in the animals. Lecithin serves principally to emulsify fats in the feeds, improving their digestion and thus increasing weight gain. This is especially important in calf milk replacer formulations and fish foods.”

The process of the present invention is employed as a batch process. In a typical process according to the present invention, “mixed triglycerides, fatty acids, and crude lecithins (TFCL)” wet or dried”, or a blend thereof, are added to a production vessel. The production vessel should be adapted to supply heat to the vessel contents, as well as to remove heat there from. The production vessel should also be adapted to mix the vessel contents under high shear to form a homogenous admixture of the vessel contents. Examples of reaction vessels suitable for use with the present invention include batch reactors, indirectly or directly heated, with multiple agitation and shear elements, suitable for very high viscosity materials.

The economic advantages provided by the process of the present invention are obtained when “mixed triglycerides, fatty acids, and crude lecithin (TFCL)” feed stocks are employed having greater than about 0-45 weight % of the fatty acid content in the form of fatty acids or fatty glycerides and greater than 0-45crude lecithin. Typical fatty acid feed stocks range in fatty acid content between C.sub.10 and C.sub.22 fatty acids and fatty acid glycerides. The present invention is also operative with lower glyceride content fatty acid feed stocks, and with glyceride-free fatty acid feed stocks. However, the method of the present invention may be employed with fatty acid feed stocks in which from about 0% to about 45% by weight of the fatty acids are in glyceride form.

Unlike prior arts the present invention incorporates lecithin and provides a mechanism for emulsification of fat in the post rumen area and enhances fat absorption adding a unique nutritional benefit while providing a source of ruminally protected choline (RPC).

According to Nutritional Requirements of Dairy Cattle, 7^{th} Revised Edition, 2001, National Research Council, Subcommittee on Dairy Nutrition, Chapter 3 pp. 28 “Fatty acid emulsification in the post rumen and micelle formation in the small intestine is essential for the efficient absorption of fat” (1).

Preferred feed stocks include essentially any “wet or dried products containing (TFCL) from the vegetable oil seed degumming processes and determined to be nutritionally beneficial to a ruminant. Lecithins and mixed triglycerides/fatty acids, with nutritionally beneficial fatty acid profiles, are readily identified by those of ordinary skill in the art. Vegetable oils such as soybean oil, canola oil, sunflower oil, olive oil, corn oil, and the like, thereof, may also be used.

Such vegetable oil “wet or dried gum” feed stocks typically contain from about 10 to about 70 weight % of the fatty acid content in the form of fatty acids or fatty glycerides, from about 0 to about 70% by weight of crude lecithin, and less than 5-30% by weight of moisture, insolubles and unsaponifiables. The free fatty acid content may be increased by adding fatty acid distillates to the feedstock.

Calcium oxide is added to the “mixed triglycerides, fatty acids, and crude lecithins (TFCL)” feed stock in the range of from about 10 to about 30% by weight of the total composition. A calcium oxide level between about 12 and about 18% by weight of the total composition is preferred.

Water is then added to hydrate the calcium oxide to its hydroxide form, creating a large amount of exothermic heat. Additional heat is added to the admixture to increase the temperature to a range between about 90 and about 250.degree. C. For lower levels of calcium oxide and lower levels of free fatty acids, higher temperatures should be employed. In accordance with the present invention, calcium hydroxide may be substituted for calcium oxide and a stoichiometric equivalent of water. Calcium oxide should be added in divided portions to prevent voluminous foaming and so as to provide efficient utilization of the reaction vessels working volume.

Feed stocks with higher triglyceride/free fatty acid ratios require higher temperatures than feed stocks with increased amounts of free fatty acids since the energy of activation required is lower since there is less triglycerolysis.

A reaction temperature between 160 C. and 250 degrees C. with calcium oxide levels of 5-10% is preferred for feed stocks of lower PUFA (polyunsaturated fatty acid)/triglyceride content. Levels of 10-15% calcium oxide and temperatures closer to 220-250.degrees C. for feed stocks of higher PUFA/triglyceride content are preferable. Proper amounts of calcium oxide and water, as well as the optimum temperature to employ, can be readily determined by those of ordinary skill in the art without undue experimentation.

The reaction can be performed under atmospheric pressure. However the art is improved by the present invention in supplying an inert atmosphere to prevent any degradation of the fatty acids or lecithin. It has been found that nitrogen sparge applied to the reaction mixture prior to the calcium addition, devoids the reaction mixture of oxygen and inhibits the formation of degradation products that give strong offensive odor and bitter taste to the final product. This improvement of the present invention improves the palatability of the product.

Between about 10% and about 100% by weight of water relative to the calcium oxide is added to the admixture. An amount between about 10 and about 30% by weight is preferred. The amount of time required for the reaction is typically between about 10 to about 60 minutes, and more typically between about 15 and about 45 minutes. The reaction is easily identified by the transformation of the admixture into a caramel-like mass. Upon further heating and agitating, the mass further transforms into a taffy-like material, which, upon transfer from the reaction vessel, can easily be processed into free-flowing particles.

A biologically active material can be included as an optional ingredient in the invention process. By the term “biologically active material”, it is meant any substance capable of being administered orally in a feed composition and which is susceptible to inactivation in the rumen by microbes and digestive juices. The biologically active material can be selected from a broad variety of nutrients and medicaments, either as a single component or as a mixture of components, which are illustrated by the following list of active molecular species:

1. Sugars and complex carbohydrates which include both water-soluble and water-insoluble monosaccharides, disaccharides, and polysaccharides. Particularly preferred carbohydrates include cane molasses and sugar beet byproducts.

2. Amino acid ingredients, either singly or in combination, which include arginine, histidine, isoleucine, leucine, lysine, methionine, phenylalanine, threonine, tryptophan, valine, tyrosine ethyl HCL, alanine, aspartic acid, glutamic acid, sodium glutamate, potassium glutamate, glycine, proline, serine, cystine ethyl HCL, and the like; and analogues and salts thereof.

3. Vitamin ingredients, either singly or in combination, including thiamine HCL, riboflavin, pyridoxine HCL, niacin, inositol, choline chloride, calcium pantothenate, biotin, folic acid, ascorbic acid, vitamin B.sub.12, p-aminobenzoic acid, vitamin A acetate, vitamin K, vitamin D, vitamin E, and the like.

4. Trace element ingredients, either singly or in combination, including compounds of cobalt, copper, manganese, iron, zinc, tin, nickel, chromium, molybdenum, iodine, chlorine, silicon, vanadium, selenium, calcium, magnesium, sodium and potassium.

5. Protein ingredients as obtained from sources such as, cottonseed meal, soybean meal, rapeseed meal, sunflower seed meal, canola meal, safflower meal, dehydrated alfalfa, corn gluten meal, soybean protein concentrate, and potato protein.

6. Medicament ingredients, either singly or in combination, including promazine hydrochloride, chloromedoniate acetate, chlorotetracycline, sulfamethazine, monensin, sodium monensin, poloxaline, oxytetracycline, BOVATEC, and the like.

7. Antioxidants, including butylated hydroxyanisole, butylated hydroxytoluene, tertiary-butylhydroquinone, tocopherols, propyl gallate and ethoxyquin; and preservatives, including sodium sorbate, potassium sorbate, sodium benzoate, propionic acid, .alpha.-hydroxybuteric acid, and the like.

The biologically active material is present at a level up to about 20 weight %, based on the weight of the C.sub.10-C.sub.22 fatty acid ingredient.

The fatty acid/crude lecithin calcium salt matrix rumen bypass feed supplements of the present invention may be conveniently fed to a ruminant admixed with a conventional ruminant feed. The feeds are typically vegetable materials edible by ruminants, such as legume hay, grass hay, corn silage, grass silage, legume silage, corn grain, oats, barley, distiller's grain, brewer's grain, soya bean meal and cottonseed meal. Desirably, the amount of the calcium salt supplement in such an admixture does not exceed about 10% of the dry solids content of the feed and is preferably about 3 to 5% of the dry solids content of the feed.

There is no particular lower limit for the amount of the fatty acid/crude lecithin calcium salt matrix product to be added to the ruminant feed, although in practice amounts of the calcium salt below about 1% of the dry solids content of the feed are too small to provide significant amounts of energy to the ruminant. It is known to feed small amounts of fatty acid mixtures to cattle only as an inert protective agent for certain feed supplements such as methionine, as is disclosed in U.S. Pat. No. 3,959,493. However, the amounts of fatty acids fed to cattle in this manner are much smaller than contemplated with the feed supplements of the present invention.

The fatty acid/crude lecithin calcium salt matrix of the present invention is an ideal nutritional supplement for cattle, particularly lactating dairy cattle, for which conventional cattle feeds, such as corn and alfalfa, often fail to provide sufficient energy, especially during periods of stress or heavy milk production. The present invention unlike prior arts provides incorporation of ruminally protected fatty acid which have an energy value 2.5 times that of crude protein crude and ruminally protected lecithin and thus provides a mechanism for emulsification of fats, oils or fatty acids in the post rumen area and enhances fat absorption. Further unique to this invention a source of (RPC) ruminally protected choline is provided through the presence of lecithin in the fatty acid calcium salts/crude lecithin matrix.

The feed supplements of the present invention contain elevated levels of calcium salts of long chained fatty acids and calcium salts of unsaturated fatty acids complexed with dried crude lecithin that improve energy utilization in cattle.

Accordingly, the rumen bypass feed supplements of the present invention are particularly well suited for use as nutritional supplemental additives for cattle feeds. The following non-limiting examples set forth herein below illustrate certain aspects of the invention. All parts and percentages are by weight unless otherwise noted, and all temperatures are in degrees Celsius.

### EXAMPLES

### Example 1

Ingredients:

380 grams “mixed triglycerides, fatty acids, and crude lecithins (TFCL)”

100 grams CaO

50 grams water

The TFCL was heated to 70.degree. C., and the CaO was added and thoroughly mixed. The TFCL had a free fatty acid/triglyceride concentration from about 5 to about 45% and crude lecithin content of 5-45%. The water content is adjusted to a near stoichiometric equivalent based on the amount of calcium oxide by either the addition of water or by the removal of water via vacuum sufficient to hydrate the CaO in a sealed pressure vessel. The reaction vessel was sparged with nitrogen for 45 min. When the hydration was complete, the temperature was increased to 150.degree. C., with mixing. Ten minutes later, the mixture was cooled to below 100.degree. C. using an addition of 0-15% cold tap water and the pressure vessel was opened to permit drying of the water that was released from the mixture. When the mixture's moisture was below about 5 to about 8%, it was dumped from the vessel and allowed to cool below the softening point of the calcium salts. The mixture was then spread out in a thin layer and finely granulated. The resulting rumenally protected powder had a total fat content of about 0 to 45%, from 6 to 8% glycerol, lecithin of about 0-45% and 5 to 15% calcium. The product is analogous to the commercially available rumen protected fats that are calcium salts of long chained fatty acids but with the advantage of the nutritional benefits of ruminally protected crude lecithin.

### Example 2

Ingredients:

380 grams of dried “mixed triglycerides, fatty acids, and crude lecithins (TFCL)”

100 grams CaO

100 grams water

The dried (TFCL) was heated to 70.degree. C., and the CaO was added and thoroughly mixed. The “dried (TFCL) had a free fatty acid/triglyceride concentration from about 5 to about 45% and crude lecithin content of 5-45%. The water content is adjusted to a near stoichiometric equivalent based on the amount of calcium oxide by either the addition of water or by the removal of water via vacuum sufficient to hydrate the CaO in a sealed pressure vessel. The reaction vessel was sparged with nitrogen for 45 min. When the hydration was complete, the temperature was increased to 150.degree. C. and continued mixing. Ten minutes later, the mixture was cooled to below 100.degree. C. using an addition of 0-15% cold tap water and the pressure vessel was opened to permit drying of the water that was released from the mixture. When the mixture's moisture was below about 5 to about 8%, it was discharged from the vessel as a granular free flowing powder. The resulting rumenally protected powder had a total fat content of about 0 to 45%, from 6 to 8% glycerol, lecithin of about 0-45% and 5 to 15% calcium. The product is analogous to the commercially available rumen protected fats that are calcium salts of long chained fatty acids but with the advantage of the nutritional benefits of ruminally protected crude lecithin.

The present invention thus provides, a process by which, a fatty acid/crude lecithin calcium salt matrix suitable as a rumen bypass feed supplement, in the form of a free-flowing granular material, may be prepared in a single decomposition reaction from commercially available vegetable oil seed feedstock comprising “mixed triglycerides, fatty acids, and crude lecithins” derived from the degumming process of the alkali, caustic or “wet” refining of vegetable oils. The product of this invention provides a source of ruminally protected choline (RPC) and ruminally protected polyunsaturated fatty acids both beneficial to the bovine diet.

The foregoing examples and description of the preferred embodiment should be taken as illustrating, rather than as limiting, the present invention as defined by the claims. As will be readily appreciated, numerous variations and combinations of the features set forth above can be utilized without departing from the present invention as set forth in the claims. Such variations are not regarded as a departure from the spirit and scope of the invention, and all such modifications are intended to be included within the scope of the following claims.

1. A method for the preparation of a mixture of fatty acid/crude lecithin calcium salt matrix product comprising: forming an admixture of reactive ingredients derived from products of the alkali, caustic or wet refining processing of vegetable oils and consisting of (a) C.sub.10-C.sub.22 or higher fatty acid mixture having greater than about 30 weight % of the C.sub.10-C.sub.22 fatty acid content in the form of mixed vegetable fatty acids and/or fatty acid glycerides and (b) from about 10 to about 30% of the total admixture weight of calcium oxide, and (c) 10 to about 45% crude lecithin. Water is then added to the admixture in an amount between about 10% and about 20% by weight relative to the amount of calcium oxide.

2. The composition of claim 1 wherein said crude lecithin phospholipids is non-hydratable whereby said crude lecithin phospholipids pass more or less intact through the rumen into the intestine.

3. The composition of claim 1, further comprising phosphatidylcholine in said crude lecithin composition in an amount effective to disintegrate said composition in the post-ruminal digestive tract.

4. The composition according to claim 1 wherein the amount of crude lecithin is between about 10% and 45% by weight of the total composition.

5. Heating said admixture to a temperature between about 150.degree. and 250.degree. C., so that said fatty acid glycerides saponify to form fatty acid calcium salts.

6. The method of claim 1, further comprising the step of cooling using a novel evaporative cooling technique, said admixture and forming a solid, rumen protected free-flowing and granular fatty acid/crude lecithin calcium salt matrix product.

7. The method of claim 1, wherein said C.sub.10-C.sub.22 or higher mixed vegetable fatty acids and/or fatty acid glycerides content between about 30 and about 100 weight %.

8. The method of claim 1, wherein said C.sub.10-C.sub.22 or higher fatty acid/triglyceride and crude lecithin mixture is derived from a feedstock selected from the vegetable oil group consisting of soybean, canola, palm, rapeseed, corn and/or cotton.

9. The method of claim 1, wherein said admixture contains between about 10% and about 30% by weight of calcium oxide.

10. The method of claim 1, wherein said temperature is between about 160 and about 260.degree. C.

11. The method of claim 1, wherein the term crude lecithin is mixed lecithin phospholipids from the alkali, caustic or wet refining processing of vegetable oils and refers tophosphatidyl choline (PC). However, as used by commercial suppliers, the term crude lecithin (CL) refers to a product derived from vegetable oils, especially soybean oil. In addition to phosphatidyl choline, crude lecithin derived from vegetable oil includes phosphatidyl ethanolamine (PE), phosphatidyl inositol (PI), phosphatidic acid (PA), phosphatidyl serine (PS), cyclolipids, and other components such as free sugars, metals and free fatty acids. Because they contain several phosphatidyl derivatives, commercial lecithins are often referred to as phosphatides or phosphatide concentrates. Other synonymous terms for phosphatide concentrates include wet gums or wet lecithin.

12. The method of claim 1, wherein said feedstock (mixture of fatty acid/triglycerides and crude lecithin) originates from the alkali, caustic or wet refining processing of vegetable oils of oil seed stocks. “Wet processing” referenced by US Patents employing conventional acidic aqueous solutions of selected mineral acids are incorporated into the oil by high/low shear forces for emulsification purposes and further demineralized water washes and subsequent separation techniques are used to remove both hydratable phosphatides (HPs) and non-hydratable phophatides (NHPs). And “caustic and alkali” refining methods widely used today in the oil seed industry and being a well known art.

13. The method of claim 12, wherein said feedstock (mixture of fatty acid/triglycerides and crude lecithin) originates from the alkali, caustic or “wet refining” processing of vegetable oils seed stocks. Some oil seed processors continue the processing by drying the mixed triglyceride, fatty acid and lecithin mixture producing a “dried mixture” suitable for conversion to a solid, rumen protected free-flowing and granular fatty acid/crude lecithin calcium salt matrix product.

14. The method of claim 12, wherein said vegetable oil seed derived feed stock is devoid of animal derived products or byproducts capable of possible transmission of BSE and providing conversion to a suitable feed ingredient with rumen bypass qualities.

15. The method of claim 1, wherein the reaction is undertaken in an inert nitrogen atmosphere to prevent formation of unwanted degradation byproducts that produce bitter taste and offensive odor.

16. The method of claim 1, wherein the produced rumen protected free-flowing and granular fatty acid/crude lecithin calcium salt matrix product contains and is a source of ruminally protected choline (RPC).

17. The method of claim 1, wherein said admixture further comprises a biologically active material or other nutritionally beneficial materials compatible with the process.

18. The method of claim 17, wherein said biologically active material is an amino acid.
